(19) United States
(12) Patent Application Publication
(10) Pub. No.: US 2021/0298325 A1
(43) Pub. Date: Sep. 30, 2021

(54) Faux Animal Bone Structure And Plant-Based Meat Substitute Assembly

(71) Applicants: Derrick Snodgrass, JR., Anderson, IN (US); Latoija Snodgrass, Anderson, IN (US)

(72) Inventors: Derrick Snodgrass, JR., Anderson, IN (US); Latoija Snodgrass, Anderson, IN (US)

(21) Appl. No.: 16/834,523

(22) Filed: Mar. 30, 2020

(51) Int. Cl. A23J 3/22; A23L 19/00; A23L 27/26; A23J 3/14

(52) U.S. Cl. CPC A23J 3/227; A23L 19/03; A23V 2002/00; A23J 3/14; A23L 27/26

(57) ABSTRACT

A faux animal bone structure and plant-based meat substitute assembly for imitating the experience of consuming real animal protein includes a bone-shaped structure. The bone-shaped structure is heat resistant to cooking temperatures and represents an animal bone commonly served in bone-in food such as, but not limited to, chicken wings, chicken legs, ribs, steaks, fish, and the like. A plant-based meat substitute is coupled to the bone-shaped structure. The plant-based meat substitute conforms to the shape of the animal protein typically coupled to the respective bone-shape of the bone-shaped structure.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to bone structure replica devices and more particularly pertains to a new bone structure replica device for imitating the experience of consuming real animal protein.

### (2) Description of Related Art Including Information Disclosed Under 37 CFR 1.97 and 1.98

The prior art relates to bone structure replica devices for various purposes including academic study, novelty, medical, and confectionary. However none of the existing devices that are accurate anatomical representations of animal bones designed for food products and use with plant-based meat substitutes.

### BRIEF SUMMARY OF THE INVENTION

An embodiment of the disclosure meets the needs presented above by generally comprising a bone-shaped structure. The bone-shaped structure is heat resistant to cooking temperatures and represents an animal bone commonly served in bone-in food such as, but not limited to, chicken wings, chicken legs, ribs, steaks, fish, and the like. A plant-based meat substitute is coupled to the bone-shaped structure. The plant-based meat substitute conforms to the shape of the animal protein typically coupled to the respective bone-shape of the bone-shaped structure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a faux animal bone structure and plant-based meat substitute assembly according to an embodiment of the disclosure.

FIG. 2 is a cross-sectional view of an embodiment of the disclosure along the line 2-2 of FIG. 1.

FIG. 3 is a front elevation view of an embodiment of the disclosure.

FIG. 4 is an isometric view of an embodiment of the disclosure.

FIG. 5 is a side elevation view of an embodiment of the disclosure.

### DETAILED DESCRIPTION OF THE INVENTION

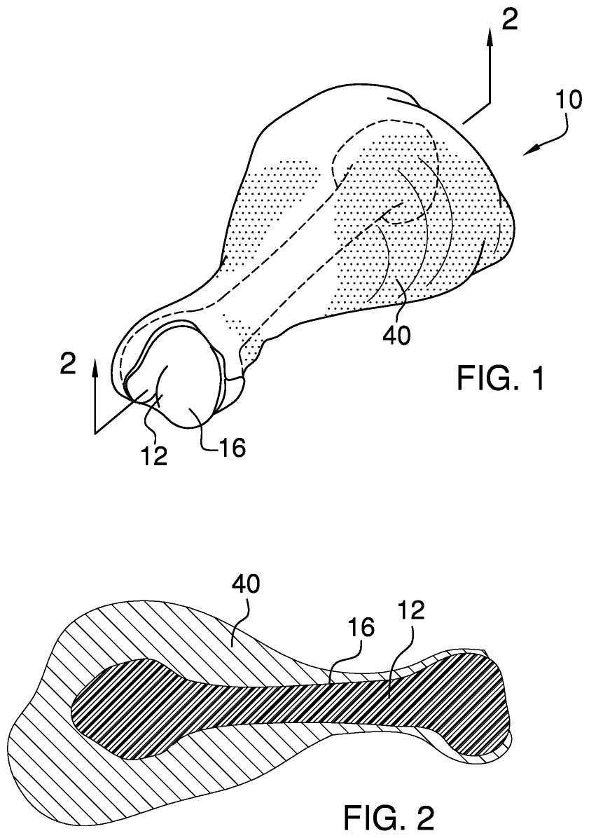

With reference now to the drawings, and in particular to FIGS. 1 through 56 thereof, a new bone structure replica device embodying the principles and concepts of an embodiment of the disclosure and generally designated by the reference numeral 10 will be described.

As best illustrated in FIGS. 1 through 5, the faux animal bone structure and plant-based meat substitute assembly 10 generally comprises a bone-shaped structure 12. The bone-shaped structure 12 is heat-resistant to cooking temperatures and represents an animal bone commonly served in bone-in food such as, but not limited to, chicken wings 14, chicken legs 16, ribs 18, steaks, fish 20, and the like. The bone-shaped structure 12 may be flavored or absorptive to flavorings such as, but not limited to, salt, soy sauce, seasonings, and the like. The bone-shaped structure 12 may be a resin substance or other heat-resistant and resilient substance that is safe for cooking and for users to place in their mouths.

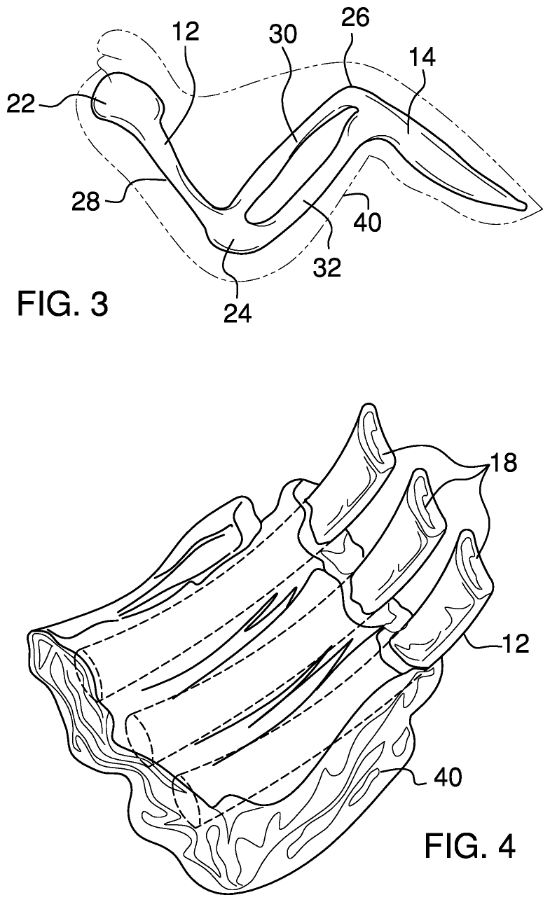

When representing a chicken wing 14 as shown in FIG. 3, the bone-shaped structure 12 includes a shoulder portion 22, an elbow portion 24, and a wrist portion 26. A humerus portion 28 extends between the shoulder portion 22 and the elbow portion 24. A radius portion 30 and an ulna portion 32 each extend from the elbow portion 24 to the wrist portion 26.

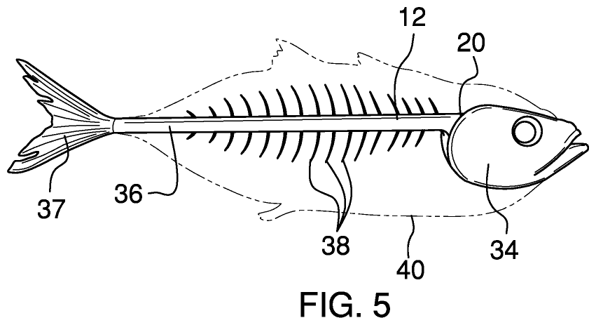

When representing fish 20 as shown in FIG. 5, the bone-shaped structure 12 includes a head portion 34, a backbone portion 36 coupled to the head portion 34, and a tailfin portion 37 coupled to the backbone portion 36. A plurality of rib bone portions 38 may be coupled to the backbone portion 36. The plurality of rib bone portions 38 may be permanently fixed to the backbone portion 36 for user convenience and safety while eating.

A plant-based meat substitute 40 is coupled to the bone-shaped structure 12. The plant-based meat substitute 40 conforms to the shape and taste of the animal protein typically coupled to the respective bone-shape of the bone-shaped structure 12. The plant-based meat substitute 40 is also flavored and textured to mimic the associated animal protein.

In use, the user may cook and consume the assembly 10 as if it were a traditional bone-in animal protein.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A faux animal bone structure and plant-based meat substitute assembly comprising:
a bone-shaped structure, the bone-shaped structure being heat-resistant to cooking temperatures, the bone-shaped structure representing an animal bone commonly served in bone-in food, the bone-shaped structure being flavored as one of salt and soy sauce, the bone structure further having a shoulder, the bone-shaped structure including a shoulder portion, an elbow portion, and a wrist portion, the bone-shaped structure further including a radius portion and an ulna portion each extending between the elbow portion and the wrist portion; and
a plant-based meat substitute coupled to the bone-shaped structure, the plant-based meat substitute conforming to the shape of the animal protein typically coupled to the respective bone-shape of the bone-shaped structure.

2. (canceled)

3. A faux animal bone structure and plant-based meat substitute assembly comprising:
a bone-shaped structure the bone-shaped structure being heat-resistant to cooking temperatures, the bone-shaped structure representing an animal bone commonly served in bone-in food, the bone-shaped structure further having a shoulder portion, an elbow portion, and a wrist portion, the bone-shaped structure further having a radius portion and an ulna portion each extending from the elbow portion to the wrist portion;
a plant-based meat substitute coupled to the bone-shaped structure, the plant-based meat substitute conforming to the shape of the animal protein typically coupled to the respective bone-shape of the bone-shaped structure; and
the bone-shaped structure being absorptive to flavorings.

4. The faux animal bone structure and plant-based meat substitute assembly of claim 1 further comprising the bone-shaped structure being a resin substance.

5. A faux animal bone structure and plant-based meat substitute assembly comprising:
a bone-shaped structure, the bone-shaped structure being heat-resistant to cooking temperatures, the bone-shaped structure representing an animal bone commonly served in bone-in food, the bone-shaped structure being a resin substance, the bone-shaped structure further having a shoulder portion, an elbow portion, and a wrist portion, the bone-shaped structure further having a radius portion and an ulna portion each extending from the elbow portion to the wrist portion; and
a plant-based meat substitute coupled to the bone-shaped structure, the plant-based meat substitute conforming to the shape of the animal protein typically coupled to the respective bone-shape of the bone-shaped structure.
